(19) United States
(12) Patent Application Publication
(10) Pub. No.: US 2019/0170533 A1
(43) Pub. Date: Jun. 6, 2019

(54) NAVIGATION BY SPATIAL PLACEMENT OF SOUND

(71) Applicant: EmbodyVR, Inc., San Mateo, CA (US)

(72) Inventor: Kapil Jain, Santa Clara, CA (US)

(21) Appl. No.: 16/013,927

(22) Filed: Jun. 20, 2018

Related U.S. Application Data
(60) Provisional application No. 62/593,853, filed on Dec. 1, 2017.

(51) Int. Cl. G01C 21/36; H04S 7/00; H04R 25/00

(52) U.S. Cl. CPC G01C 21/3629; G01C 21/3661; H04S 2420/01; H04R 25/405; H04S 7/304

(57) ABSTRACT

A direction of travel to a physical destination is determined. A sound signal is received. A signal is generated that spatializes sound in the direction of travel to the physical destination. The signal that spatializes the sound is output to the personal audio delivery device.

### RELATED DISCLOSURE

This disclosure claims the benefit of priority under 35 U.S.C. § 119(e) of U.S. Provisional Application No. 62/593,853 filed Dec. 1, 2017 entitled “Method to Navigate by Spatial Placement of Sound” the contents of which are herein incorporated by reference in its entirety.

### FIELD OF DISCLOSURE

The disclosure is related to consumer goods and, more particularly, to navigation based on spatial placement of sound.

### BACKGROUND

A user inputs a destination into a navigation system. The navigation system will then calculate directions for traveling to the destination and present the directions in piecemeal form. For example, as the user reaches various points on a route to the destination, the navigation system plays a voice command through a headphone, hearable, earbud, or hearing aid and a visual command is presented on a display screen of the navigation device indicative of a direction to travel such as “turn left” or “turn right” based on the calculated directions. In this regard, the user follows the direction of travel indicated by the navigation system to reach the destination.

In some cases, the user is engaged in an activity while using the navigation system. For example, the user is listening to music output by an audio playback device and at the same time walking, running, or driving to the destination. In the case that the navigation system is integrated with the audio playback device, the navigation system will indicate a direction of travel by causing the music to fade and audibly playing the voice command indicative of the direction to travel. Additionally, or alternatively, the navigation system will visually present the visual command indicative of a direction to travel on the display screen for the user to look at.

### BRIEF DESCRIPTION OF THE DRAWINGS

Features, aspects, and advantages of the presently disclosed technology may be better understood with regard to the following description, appended claims, and accompanying drawings where:

FIG. 1 is a block diagram of a sound spatialized navigation system arranged to spatialize sound to indicate a direction of travel to reach a destination.

FIG. 2 is a flow chart of functions associated with spatial placement of sound to facilitate navigation to reach a destination.

FIG. 3A illustrates a relationship between an x, y, z coordinate on the Earth and azimuth λ and elevation angle θ.

FIG. 3B illustrates defining the direction of travel in terms of azimuth.

FIG. 3C illustrates defining the direction of travel in terms of elevation angle.

FIG. 4 is an example visualization of sound spatialization.

FIG. 5 illustrates human anatomy affecting sound spatialization.

FIG. 6 shows an example of a non-linear transfer function for generating audio cues.

FIG. 7 is another block diagram of a sound spatialized navigation system arranged to spatialize sound indicative of the direction of travel to reach the destination.

FIG. 8 is another flow chart of functions associated with spatial placement of sound to facilitate navigation to reach the destination.

FIG. 9 is a block diagram of apparatus for facilitating navigation based on spatialization of sound.

The drawings are for the purpose of illustrating example embodiments, but it is understood that the embodiments are not limited to the arrangements and instrumentality shown in the drawings.

### DETAILED DESCRIPTION

The description that follows includes example systems, methods, techniques, and program flows that embody the disclosure. However, it is understood that this disclosure may be practiced without these specific details. For instance, this disclosure describes a process of navigation based on spatial placement of sound in illustrative examples. Aspects of this disclosure can be also applied to applications other than navigation. Further, well-known instruction instances, protocols, structures and techniques have not been shown in detail in order not to obfuscate the description.

### Overview

Existing navigation systems require that a user listen to a voice command indicative of a direction that a user is to travel to reach a destination. Additionally, or alternatively, the existing navigation systems require that a user look at a display screen displaying a visual command indicative of the direction the user is to travel to reach the destination. In either case, listening to the voice command and/or looking the display screen for the visual command intrudes on other activities also being performed by the user such as listening to music, walking, running, or driving.

Embodiments described herein are directed to a sound spatialized navigation system that spatialize sound in a direction which the user is to travel to reach a destination. Sound spatialization is a process of creating a perception that that sound is coming from a particular direction. The disclosed sound spatialized navigation system allows a user to follow the spatially placed sound to reach the destination rather than having to listen to voice commands and/or look at visual instructions on a display screen.

The disclosed sound spatialized navigation system may have a navigation system, audio playback system, and sound spatialization system. The sound spatialization system may be coupled to the navigation system and the audio playback system.

The navigation system may determine a direction which a user is to travel to reach a destination. For example, the navigation system may determine that the user is to turn left, turn slightly left, turn right, turn slightly right, go straight, go up a hill, go down a hill, among other directions based on a current physical position of the user as the user travels to a physical destination. Then, when the user reaches another position along a route to the destination, the navigation system may determine additional directions based on the other position. The additional directions may be a next turn that the user is to take or that the user is to continue downhill or uphill to reach the destination. This process may continue until the user reaches the destination.

The audio playback system may output a sound signal. The sound signal may be indicative of sound such as music or some other audio output that the user can listen to while traveling to the destination.

The navigation system may provide an indication of the direction in which the user is to travel to reach the destination to the sound spatialization system. The indication may be provided in terms of an azimuth and elevation angle. Additionally, the sound spatialization system may receive the sound signal from the audio playback system. The sound spatialization system may spatialize the sound associated with the sound signal in accordance with the indication of the direction in which the user is to travel to reach the destination.

The sound spatialization system may have a head related transfer function (HRTF) to spatialize the sound. The HRTF may comprise a plurality of non-linear transfer function that characterizes how sound is received by a human auditory system when a sound source is located at a particular location. The navigation system may use the non-linear transfer function associated with the sound source located at the azimuth and elevation angle indicative of the direction of travel to generate one or more audio cues which when interpreted by the brain creates a perception that the sound associated with the sound signal is coming from the direction of travel.

A signal indicative of the one or more audio cues may be played back by a personal audio delivery device. The personal audio delivery device may take the form of earbuds, a hearable, a headset, headphones, or a hearing aid worn by the user which spatializes the sound associated with the sound signal in the direction the user is to travel. The user may follow the spatialized sound to reach the destination. For example, if the spatialized sound is spatialized in the front, then the user is to travel ahead. As another example, if the spatialized sound is spatialized to the left, then the user is to travel to the left. As yet another example, if the spatialized sound is spatialized to the left but far ahead, then the user is to continue to travel ahead but will need to turn left. Other variations are also possible.

### DETAILED EXAMPLES

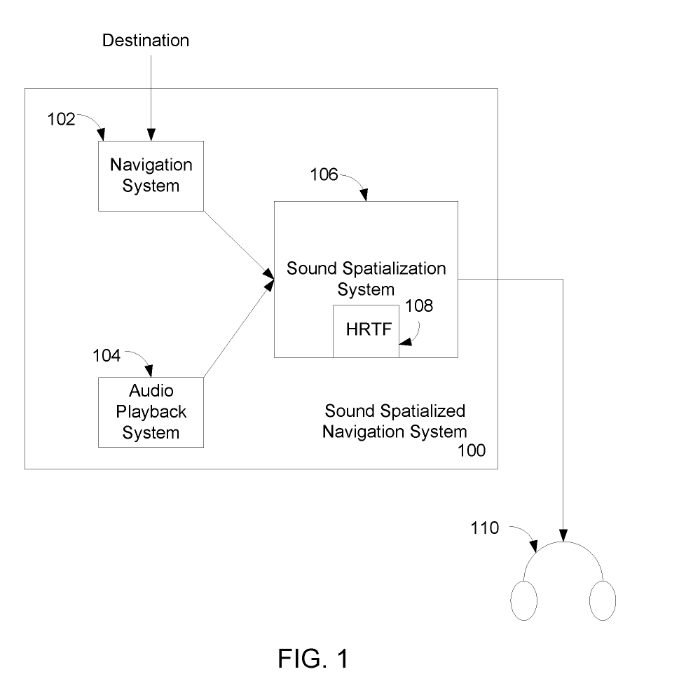

FIG. 1 is a block diagram of a sound spatialized navigation system 100 arranged to spatialize sound to indicate a direction of travel to reach a destination. The sound spatialized navigation system 100 may include a navigation system 102, an audio playback system 104, and a sound spatialization system 106. The sound spatialized navigation system 100 may be connected to a personal audio delivery device 110. The sound spatialized navigation system 100 may take the form of a standalone device or an application in a device such as a smartphone or electronic wearable device like an Apple® watch or Google® glasses.

The navigation system 102 may receive as an input a physical destination to travel to, calculate directions for traveling to the destination, and output indications of the directions. The input may be provided by a user via a user interface associated with the navigation system 102 which may take the form of a keyboard or touch screen among other examples. To facilitate the calculation of the directions, a current position (e.g., physical position) of the personal audio delivery device 110 may be determined. The current position may be determined in many ways, e.g., based on global positioning satellite signals, WiFi signals and/or cellular signals. In one example, the navigation system 102 may determine the current position of sound spatialized navigation system 100 by processing the signals using well known position location algorithms. The personal audio delivery device 110 may be near or integrated with the sound spatialized navigation system 100. As a result, the current position of the sound spatialized navigation system 100 may approximate the current position of the personal audio delivery device 110. In another example, the personal audio delivery device 110 may process the signals using well known position location algorithms to determine its current position. The personal audio delivery device 110 may be arranged to determine its current position when it can be located remotely from the sound spatialized navigation system 100. The personal audio delivery device 110 may provide its current position to the navigation system 102.

Based on the current position of the personal audio delivery device, the navigation system 102 may determine a route to the destination and then calculate the directions to reach the destination. The navigation system 102 may output the directions in piecemeal form as the current position changes. For example, the navigation system 102 may output an indication of a direction of travel such as a turn that the user is to take or that the user is to continue downhill or uphill. When the user reaches another point on the route, the navigation system 102 may output another indication of direction of travel such as another turn. In this regard, a user can follow the indications of directions in piecemeal form output by the navigation system 102 to reach the destination.

The audio playback system 104 may be arranged to output a sound signal indicative of sound which a user may be listening to via the personal audio delivery device while traveling to the destination. The audio playback device 104 may store sound files indicative of the sound which the user may be listening to. Additionally, or alternatively, the audio playback system 104 may receive sound files from an external source via a wired or wireless connection. The sound files may take the form of music and/or some other sound.

The sound spatialization system 106 may receive an indication of the direction of travel to reach the destination from the navigation system 102. Additionally, the sound spatialization system 106 may receive the sound signal from the audio playback system 104. The sound spatialization system 106 may spatialize the sound associated with the sound signal in accordance with the indication of the direction of travel and a head related transfer function 108 (HRTF) as described in further detail below.

The sound spatialized navigation system 100 may output an indication of the spatialized sound to the personal audio delivery device 110. The personal audio delivery device 110 may take a variety of forms, such as a headset, hearable, hearing aid, headphones, earbuds, etc. In some examples, the personal audio delivery device 110 may cover at least a portion of a pinna of a user. The personal audio delivery device 110 may be connected to the sound spatialized navigation system 100 via a wireless or wired connection or integrated as part of the sound spatialized navigation system 100 (not shown). The personal audio delivery device 110 may receive the indication of the spatialized sound and output the spatialized sound to the user. The user may then follow the spatialized sound to reach the destination.

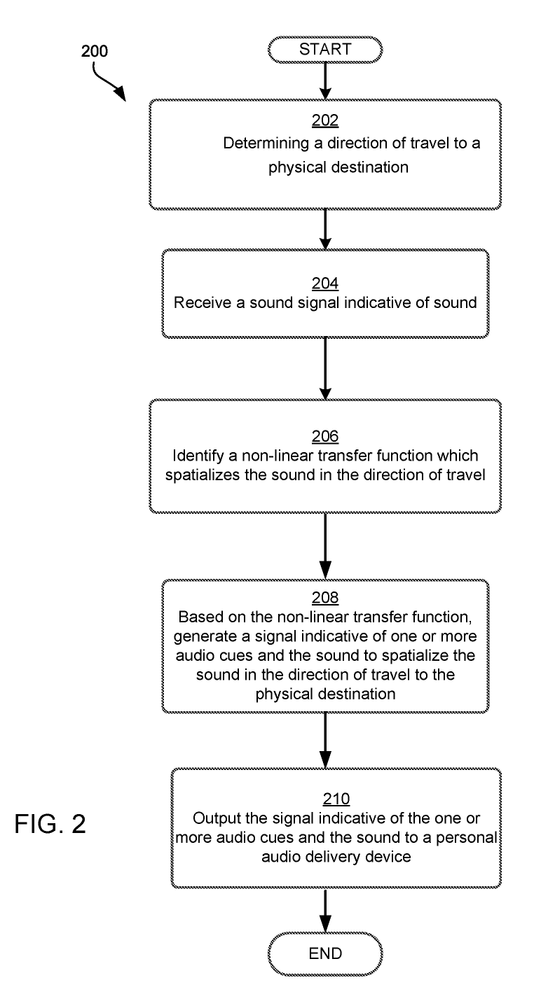

FIG. 2 is a flow chart of functions 200 associated with spatial placement of sound to facilitate navigation to a destination. These functions may be performed by the sound spatialized navigation system described in FIG. 1 and/or in conjunction with other hardware and/or software modules.

Briefly, at 202, a direction of travel is determined to a physical destination. At 204, a sound signal indicative of sound is received. At 206, a non-linear transfer function is identified which spatializes the sound in the direction of travel. At 208, a signal indicative of one or more audio cues and the sound is generated based on the non-linear transfer function to spatialize the sound in the direction of travel to the physical destination. At 210, the signal indicative of the one or more audio cues and the sound is output to a personal audio delivery device.

Methods and the other process disclosed herein may include one or more operations, functions, or actions. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In addition, for the methods and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, each block in the FIG. 2 may represent circuitry that is wired to perform the specific logical functions in the process.

At 202, a direction of travel is determined to a physical destination. The direction of travel may be indicated by one or more of an azimuth and elevation angle.

The navigation system may determine a current position (e.g., physical position) of the personal audio delivery device 110. This position may be determined in terms of a latitude and longitude. Additionally, the navigation system may determine a latitude and longitude of a position on a route to the destination. The navigation system may convert the longitude and latitude associated with the current position and position on the route to the destination to a set to corresponding coordinates such as x, y, z coordinates according to the following equations:

X=R*Cos(latitude)*Cos(longitude)

Y=R*Cos(latitude)*Sin(longitude)

Z=R*Sin(latitude)

where R is an approximate radius of earth (e.g. 6371 Km). The coordinates of the current position and position on the route to the destination may be then converted to an azimuth and elevation angle.

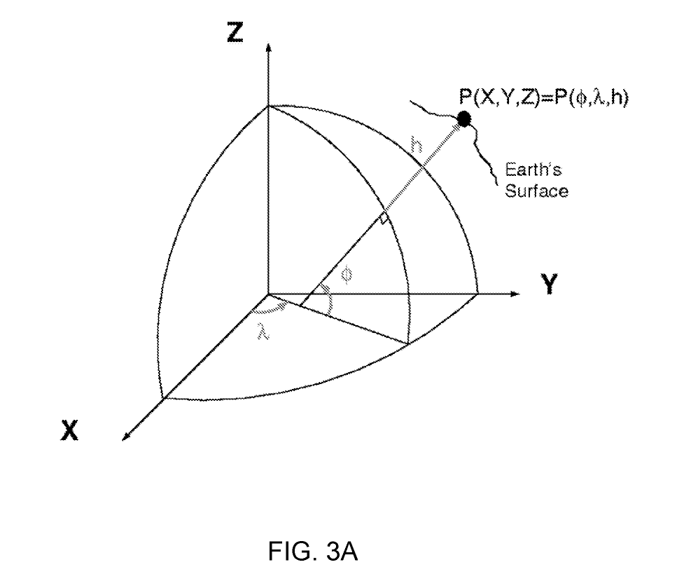

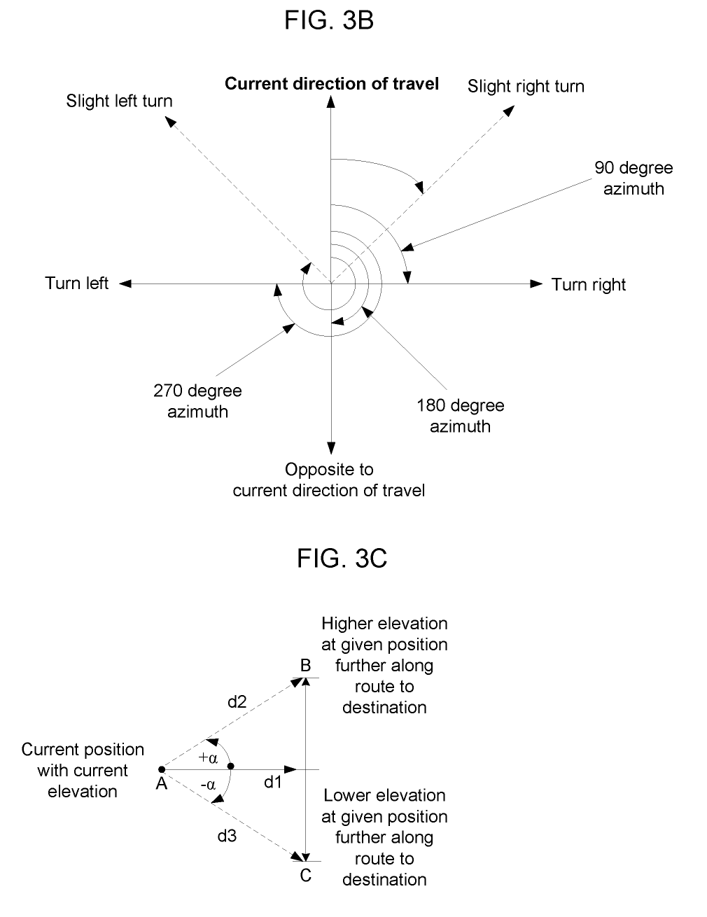

FIG. 3A illustrates a relationship between x, y, z coordinate on the Earth and azimuth λ and elevation angle θ. The x, y, z coordinate may be converted to an azimuth λ and elevation angle θ based on well-known trigonometric functions. Then, a difference between the azimuth and elevation angle associated with the current position and point on the route is calculated. This difference, in terms of azimuth and elevation angle, is indicative of the direction of travel.

The azimuth and elevation angle may be calculated in other ways as well. For example, the navigation system may determine the current position and point on the route to the destination directly in terms of x, y, z coordinates. Likewise, the current position may be determined directly in terms of x, y, z coordinates. In this case, no conversion from latitude and longitude to x, y, z coordinates would be needed. In other cases, the navigation system may provide one or more of an indication of the current position and point on the route to the destination to the sound spatialization system 106 and the sound spatialization system 106 may calculate the azimuth and elevation angle. Yet other variations are also possible.

FIG. 3B shows that the azimuth may be an angle ranging from 0 to 360 degrees from a current direction of travel. For instance, if the direction of travel is to the left of the current direction of travel and the user is to turn left, then the azimuth is 270 degrees. As another example, if the direction of travel is to the right of the current direction of travel and the user is to turn right, then the azimuth is 90 degrees. As yet another example, if the direction of travel is to straight ahead and the user is to continue straight ahead, then the azimuth is 0 degrees. As yet another example, azimuths may take the form of angles between 0 and 90 degrees or 270 and 0/360 degrees which indicates slight turns in a right or left direction. To illustrate further, azimuths between 90 degrees and 270 degrees may indicate traveling in an opposite direction to a current direction of travel.

FIG. 3C shows that the elevation angle may be an angle ranging from 0 to +/−90 degrees. The elevation angle may indicate whether a direction of travel is uphill or downhill. If the elevation further along the route at C is lower than a current elevation, then the direction of travel is downhill and the elevation angle may be negative. If the elevation further along the route at B is higher than a current elevation, then the direction of travel is uphill and the elevation angle may be positive. The elevation angle may be represented in other ways as well.

In some cases, the navigation system may output a discrete instruction such as turn left or turn right or an elevation such as 100 ft at a given position along the route to the destination and not an azimuth and/or elevation angle. The sound spatialized navigation system may be arranged to convert the discrete instruction and/or elevation into the azimuth and elevation. The azimuth and elevation associated with the direction of travel may be determined in other ways as well.

At 204, a sound signal may be received. The sound signal may be output by an audio playback system and associated with sound to be played back by a personal audio delivery device such as a headset, hearable, hearing aid, headphones, and/or earbuds.

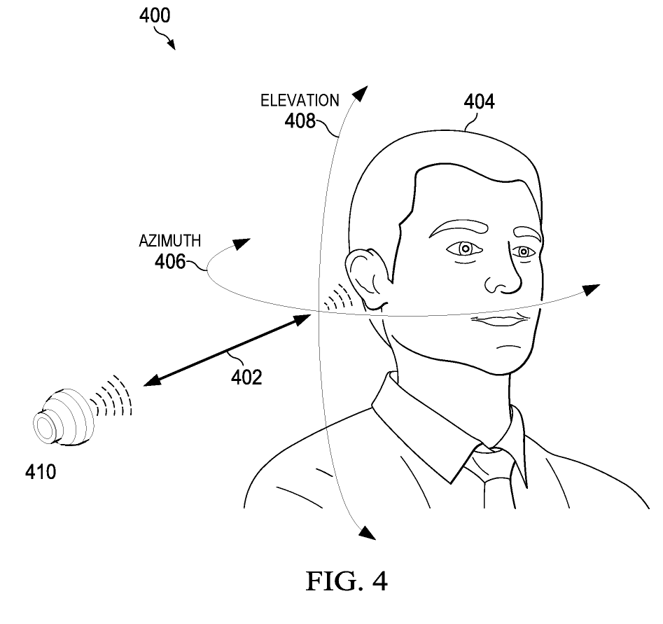

FIG. 4 is an example visualization 400 of sound spatialization. Sound spatialization may involve perceiving sound 402 by a listener 404 as coming from a given azimuth 406 and elevation angle 408. The azimuth 406 may be an angle in a horizontal plane between a listener 404 and a sound source 410 which outputs the sound 402. The elevation angle 408 may be an angle in a vertical plane between the listener 404 and the sound source 408 which outputs the sound 402.

The perception of the sound coming from the given azimuth 406 and elevation angle 408 may be based on how the sound interacts with human anatomy. The interaction produces one or more audio cues that the brain can interpret to perceive that the sound is coming from the given azimuth 406 and elevation angle 408.

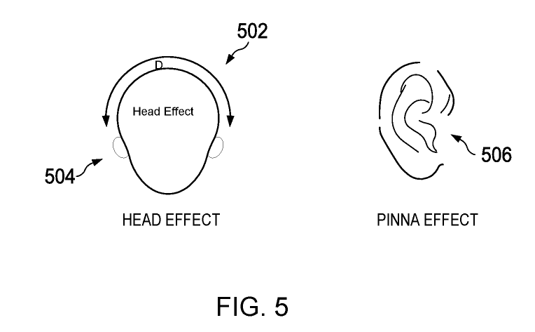

FIG. 5 illustrates the human anatomy affecting sound spatialization. Interaction of the sound with an overall shape of the head 502 including ear asymmetry and distance D between the ears 504 may generate audio cues indicative of azimuth and elevation from where the sound is coming from. This is modeled as head effect. Also, interaction of the sound with the shape, size, and structure of a pinna 506 of an ear may generate audio cues indicative of an elevation from where the sound is coming from. Each person may have differences in pinna, and similarly head size. As a result, the audio cues for spatialization of sound for one user might not be the same for another user.

Personal audio delivery devices such as headphones, earbuds, headsets, hearables, and hearing aids may output sound directly into a human auditory system. For example, an earcup of a headphone may be placed on the pinna and a transducer in the earcup may output sound into an ear canal of the human auditory system. The earcup may cover or partially cover a pinna. As another example, components such as wires or sound tubes of an earbud, behind-the-ear hearing aid, or in-ear hearing aid may cover a portion of the pinna. The pinna might not interact with such sounds so as to generate the audio cues to perceive the azimuth and/or elevation angle where the sound is coming from. As a result, the spatial localization of sound may be impaired.

A head related transfer function (HRTF) may be used to facilitate spatial localization of sound when wearing the personal audio delivery device. The HRTF may artificially generate audio cues so that sound can be spatialized even though it may not interact with certain human anatomy. The HRTF may comprise a plurality of non-linear transfer functions that characterizes how sound is received by a human auditory system based on interaction with the pinna and/or head. The non-linear transfer function may be used to artificially generate the audio cues so as to perceive sound as coming from a given azimuth and/or elevation angle.

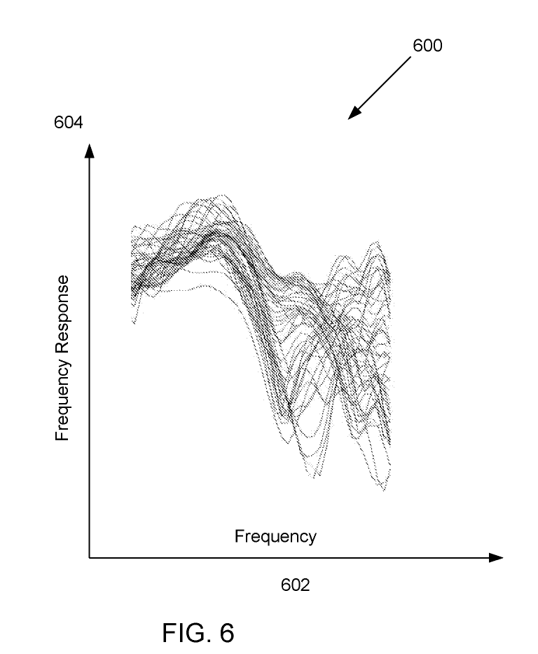

FIG. 6 shows an example of the non-linear transfer function 600 for generating audio cues. A horizontal axis 602 may represent a frequency heard at a pinna, e.g., in Hz, while a vertical axis 604 may represent a frequency response, e.g., in dB. The non-linear transfer function may characterize how a pinna transforms sound. For example, the non-linear transfer function 600 may define waveforms indicative of frequency responses of the pinna when a sound source is at different elevations. For example, each waveform may be associated with a particular elevation of the sound source. Further, each waveform may be associated with a same azimuth of the sound source. In this regard, waveforms for a given elevation and azimuth may define the frequency response of the pinna of that particular user when sound comes from the given elevation and azimuth.

Each person may have differences in pinna, and similarly head size. As a result, the HRTF and associated non-linear transfer functions for one user might not be used for another user. Such a use would result in audio cues being generated such that the sound source is perceived coming from a different spatial location from where it is intended to be perceived. In this case, the HRTF may be personalized to the person. Various methods for personalizing an HRTF to a user is described in U.S. patent application Ser. No. 15/811,295 filed Nov. 13, 2017 and entitled “Image and Audio Characterization of a Human Auditory System for Personalized Audio Reproduction”, the contents of which are herein incorporated by reference in its entirety. In other cases, the HRTF may not be personalized to a user but designed to facilitates some level of sound spatialization for a group of persons despite differences in pinna and/or head size. The HRTF in this case, referred to as a generalized HRTF, may not provide as accurate a sound spatialization as the personalized HRTF.

As noted above, the direction of travel may be associated with a given azimuth and elevation angle. At 206, a non-linear transfer function may be identified which spatialize the sound associated with the sound signal in the direction of travel, e.g., sound is perceived as coming from a given azimuth and/or elevation angle associated with the direction of travel to the physical destination.

At 208, a signal indicative of one or more audio cues and the sound may be generated based on the non-linear transfer function to spatialize the sound in the direction of travel. For example, the sound signal may be modulated with the identified non-linear transfer function to form the signal indicative of one or more audio cues and the sound. The non-linear transfer function may be an impulse response which is convolved with the sound signal in a time domain or multiplied with the sound signal in a frequency domain to generate the signal indicative of the one or more audio cues and the sound. The modulation of the sound signal with the non-linear transfer function may result in artificially generating audio cues that facilitates spatializing the sound in the direction of travel, e.g., the azimuth and/or elevation associated with the direction of travel.

At 210, the signal indicative of the one or more audio cues and the sound may be output to a personal audio delivery device. The personal audio delivery device may take the form of a headset, hearable, headphone, earbuds, earcups, and/or hearing aid. The personal audio delivery device may have one or more transducers to convert the signal indicative of the one or more audio cues to sound that the user can listen to. The sound may be spatialized in a direction which the user is to travel to reach a destination. In turn, the user may follow the spatial direction of the sound to reach a destination. In this regard, the user may not be as distracted while following navigation directions. Instead, the user can focus on other activities while traveling to the destination rather than having to listen to voice commands and/or look at visual directions on a display.

The navigation system may be arranged to provide directions at discrete intervals. In this regard, the functions 200 may be repeated at the discrete intervals along a route to the destination. For example, the sound spatialized navigation system may provide a direction as the user approaches a turn or starts to travel uphill or downhill (e.g., intermediate point on route to the destination). For example, the direction may be provided when the user reaches a predefined range (e.g., 100 ft) from a turn and/or start uphill or downhill. The sound spatialized navigation system may spatialize the sound in accordance with the direction based on the functions 200. The sound spatialized navigation system may then provide an indication that the user has completed travel in the direction (e.g., the user has made the turn or started uphill). Then sound spatialization may stop until he approaches a next turn for example (e.g., another intermediate point on route to the destination) or spatialized in a different direction (e.g., straight ahead) indicative of a new direction for the user to go in. In this regard, each time the sound spatialized navigation system provides directions, the functions 200 may be performed and the user may be provided with spatialized sound to follow as the user travels to the destination.

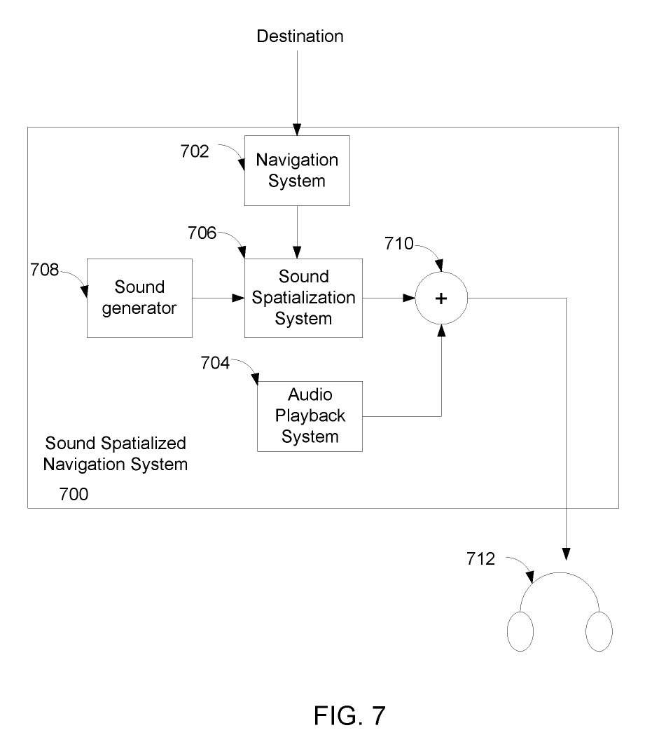

FIG. 7 is another block diagram of a sound spatialized navigation system 700 arranged to spatialize sound indicative of a direction of travel to reach a destination. The sound spatialized navigation system 700 may include a navigation system 702, an audio playback system 704, a sound spatialization system 706, a sound generator 708, a summer 710, and a personal audio delivery device 712. The navigation system 702, audio playback system 704 and personal audio delivery device 712 may be arranged in a manner similar to navigation system 102, audio playback system 104 and personal audio delivery device 110

The navigation system 702 may have an input for receiving an indication of a destination to travel to and an output which identifies a direction of travel to the destination. The sound spatialized navigation system 700 may also include a sound generator 708. The sound generator 708 may be arranged to output a sound signal indicative of sound such as an audible tone within a range of frequencies such as 2000 to 3000 Hz or a tone at a single frequency such as 2500 Hz at a given volume. In some cases, the sound may be intermittent such as a series of beeps at the single frequency or range of frequencies. The sound spatialization system 706 may spatialize sound associated with the sound signal based on the direction of travel to the destination and output a signal indicative of one or more audio cues and sound associated with the sound signal to spatialize the sound associated with the sound signal. A summer 708 may combine the signal indicative of one or more audio cues and sound associated with the sound signal with another sound signal, e.g., music, output by the audio playback device 704 and the personal audio delivery device 712 may play sound associated with the combined signal. The user may follow sound associated with the spatialized sound signal to reach the destination while also listening to sound associated with the other sound signal output by the audio playback device 704 which is not spatialized. For example, the sound associated with the spatialized signal, e.g., series of beeps, may be output in a given direction until the user completes the travel in the given direction (e.g., the user has made the turn or started uphill). Then the sound associated with the spatialized signal may stop until he approaches a next turn for example (e.g., another intermediate point on route to the destination) or spatialized in a different direction indicative of a new direction for the user to go in all while the music is playing. Other variations are also possible.

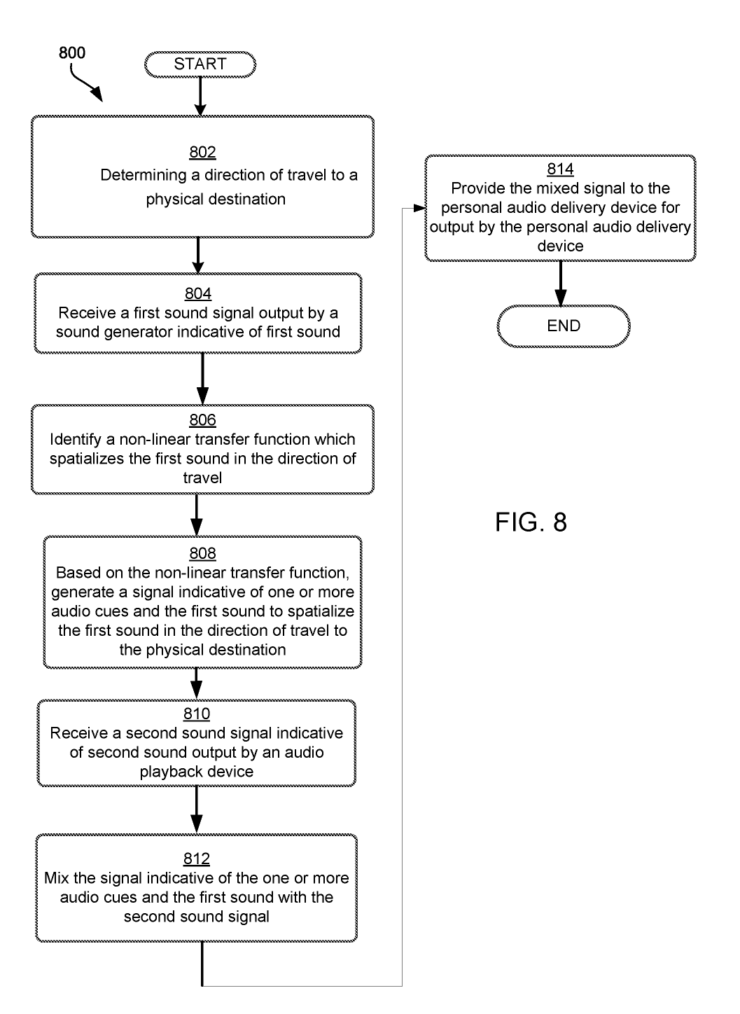

FIG. 8 is flow chart of functions 800 associated with spatial placement of sound to facilitate navigation to reach a destination. The functions 800 may be performed by the example sound spatialized navigation system described in FIG. 7 and/or in conjunction with other hardware and/or software modules.

At 802, a direction of travel is determined to a physical destination. The direction of travel may be an indication of an azimuth and/or elevation angle in which a user is to travel to reach a destination.

At 804, a first sound signal output by the sound generator is received. The first sound signal may be associated with first sound of short duration such as beeps in an audible frequency range separated by interval of time such as 1 second. The first signal may take other forms as well

At 806, a non-linear transfer function is identified to spatialize the first sound in the direction of travel. The non-linear transfer function may be identified from a personalized HRTF associated with the user for spatializing the first sound in the direction of travel, e.g., the azimuth and/or elevation angle or a generalized HRTF.

At 808, a signal indicative of one or more audio cues and the first sound may be generated based on the determined non-linear transfer function to spatialize the first sound in the direction of travel to the physical destination. For example, the non-linear transfer function may be modulated with the first sound signal to generate the one or more audio cues. The one or more audio cues when interpreted by the brain spatializes the first sound at the azimuth and/or elevation associated with the direction of travel.

At 810, a second sound signal output by the audio playback device is received. Second sound associated with the second sound signal may be music that a user listens to while traveling to the destination. At 812, the signal indicative of the one or more audio cues and the first sound is mixed with the second sound signal.

At 814, the mixed signal is provided to the personal audio delivery device for output by the personal audio delivery device. The first sound associated with the first signal may be spatialized and the second sound associated with the second signal may not be spatialized. In this regard, the user may follow the spatialized sound while listening to the second sound associated with the second sound signal to reach the destination. To illustrate, if the spatialized sound is beeps and the beeps are coming from the user's right, then the user should turn right. As another example, if the spatialized sound is beeps and the beeps are coming from the user's left, then the user should turn left. Further, while following the spatialized sound, the user may also listen to the second sound associated with the second sound signal which is not spatialized.

The navigation system may be arranged to provide directions at discrete intervals. In this regard, the functions 800 may be repeated at the discrete intervals along a route to the destination.

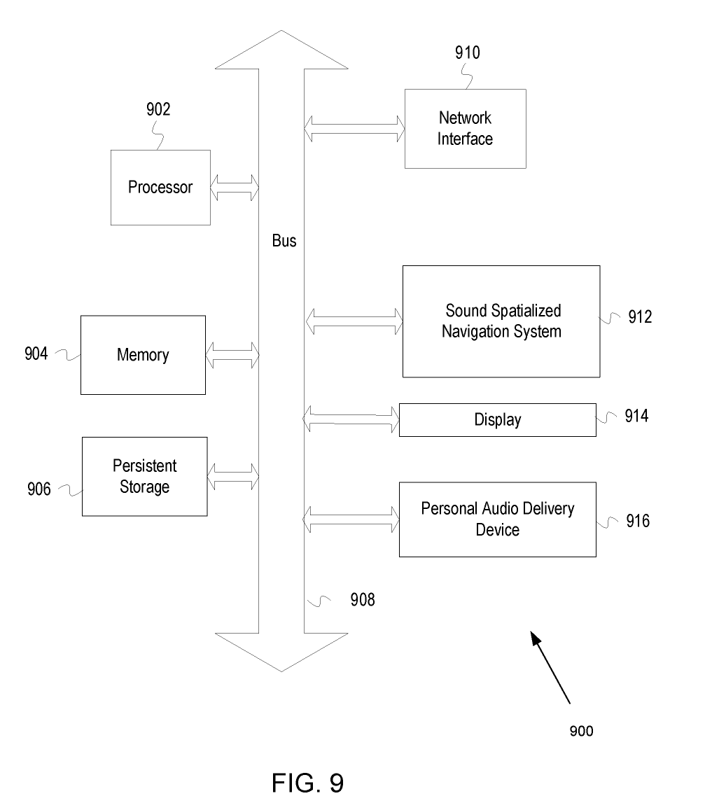

FIG. 9 is a block diagram of apparatus 900 such as a computer system for facilitating navigation based on spatialization of sound to indicate a direction to travel.

The apparatus 900 includes a processor 902 (possibly including multiple processors, multiple cores, multiple nodes, and/or implementing multi-threading, etc.). The apparatus 900 includes memory 904. The memory 904 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The apparatus 900 may also include a persistent data storage 906. The persistent data storage 906 can be a hard disk drive, such as magnetic storage device. The computer device also includes a bus 908 (e.g., PCI, ISA, PCI-Express, HyperTransport® bus, InfiniBand® bus, NuBus, etc.) and a network interface 910 in communication with the sensor tool. The apparatus 900 may have a sound spatialized navigation system 912 defining logic to spatialize sound in a direction of travel in accordance with the functions described herein.

In some cases, the apparatus 900 may further comprise a display 914. The display 914 may comprise a computer screen or other visual device. The display 914 may convey navigation information such the direction to travel in visual form. The apparatus may also have a personal audio delivery device 916 for outputting the spatialized sound to a user.

The above examples describe output of spatialized audio to a personal audio delivery device worn by a user such as headphones. The audio might be output to other audio delivery devices such as speakers in a vehicle. In this case, the user may follow spatialized sound output by the speaker in the vehicle in driving to the destination. Additionally, the above examples described determining a direction of travel based on a physical location of the personal audio delivery device. The direction of travel may be based on other physical locations such as the location of the sound spatialized navigation system, e.g., when the personal audio delivery device is not located proximate to the sound spatialized navigation system, which is then used to spatialize the sound.

The description above discloses, among other things, various example systems, methods, modules, apparatus, and articles of manufacture including, among other components, firmware and/or software executed on hardware. It is understood that such examples are merely illustrative and should not be considered as limiting. For example, it is contemplated that any or all of the firmware, hardware, modules, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “example” and/or “embodiment” means that a particular feature, structure, or characteristic described in connection with the example and/or embodiment can be included in at least one example and/or embodiment of an invention. The appearances of this phrase in various places in the specification are not necessarily all referring to the same example and/or embodiment, nor are separate or alternative examples and/or embodiments mutually exclusive of other examples and/or embodiments. As such, the example and/or embodiment described herein, explicitly and implicitly understood by one skilled in the art, can be combined with other examples and/or embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### EXAMPLE EMBODIMENTS

Example embodiments include the following:

### Embodiment 1

A method comprising: determining a direction of travel to a physical destination; receiving a sound signal indicative of sound; generating a signal that spatializes the sound in the direction of travel to the physical destination; and outputting the signal that spatializes the sound to a personal audio delivery device.

### Embodiment 2

The method of Embodiment 1, wherein the sound is music or an audio tone.

### Embodiment 3

The method of Embodiment 1 or 2, wherein the personal audio delivery device is an earbud, a headphone, a behind-the-ear hearing aid, or an in-ear hearing, wherein the personal audio delivery device covers at least a portion of a pinna.

### Embodiment 4

The method of any of Embodiment 1-3, further comprising: determining a new direction of travel to the physical destination based on a new physical location of the personal audio delivery device; generating a new signal to spatialize the sound in the new direction of travel; and outputting the new signal to the personal audio delivery device.

### Embodiment 5

The method of any of Embodiment 1-4, further comprising identifying a non-linear transfer function which spatializes the sound in the direction of travel and wherein generating the signal that spatializes the sound comprises generating the signal that spatializes the sound based on the non-linear transfer function to spatialize the sound in the direction of travel.

### Embodiment 6

The method of any of Embodiment 1-5, wherein identifying the non-linear transfer function comprises identifying the non-linear transfer function from a head related transfer function personalized to a user or a generalized head related transfer function.

### Embodiment 7

The method of any of Embodiment 1-6, wherein the direction of travel is defined by one or more of an azimuth and elevation angle.

### Embodiment 8

The method of any of Embodiment 1-7, wherein outputting the signal that spatializes the sound comprises mixing the signal with a music signal.

### Embodiment 9

One or more non-transitory computer readable media comprising program code stored in memory and executable by a processor, the program code to: determine a direction of travel to a physical destination; receive a sound signal indicative of sound; generate a signal that spatializes the sound in the direction of travel to the physical destination; and output the signal that spatializes the sound to a personal audio delivery device.

### Embodiment 10

The one or more non-transitory computer readable media of Embodiment 9, further comprising program code to identify a non-linear transfer function which spatializes the sound in the direction of travel and wherein the program code to generate the signal that spatializes the sound comprises program code to generate the signal based on the non-linear transfer function to spatialize the sound in the direction of travel.

### Embodiment 11

The one or more non-transitory computer readable media of Embodiment 9 or 10, wherein the program code to identify the non-linear transfer function comprises program code to identify the non-linear transfer function from a head related transfer function personalized to a user or a generalized head related transfer function.

### Embodiment 12

The one or more non-transitory computer readable media of any of Embodiment 9-11, wherein the direction of travel is defined by an azimuth and elevation angle.

### Embodiment 13

The one or more non-transitory computer readable media of any of Embodiment 9-12, wherein the program code to output the signal comprises program code to mix the signal that spatializes the sound with a music signal.

### Embodiment 14

The one or more non-transitory computer readable media of any of Embodiment 9-13, wherein the sound associated with the sound signal is music or an audio tone.

### Embodiment 15

The one or more non-transitory computer readable media of any of Embodiment 9-14, further comprising program code to: determine a new direction of travel to the physical destination based on a new physical location of the personal audio delivery device; generate a new signal to spatialize the sound in the new direction of travel; and output the new signal to the personal audio delivery device.

### Embodiment 16

A system comprising: a personal audio delivery device; a navigation device; program code stored in memory and executable by a processor to cause the system to: determine a direction of travel to a physical destination; receive a sound signal indicative of sound; generate a signal that spatializes the sound in the direction of travel to the physical destination; and output the signal that spatializes the sound to the personal audio delivery device.

### Embodiment 17

The system of Embodiment 16, wherein the program code to determine the direction of travel comprises program code determine a physical location of the sound spatialized navigation system or personal audio delivery device and determine the direction of travel based on the physical location of the sound spatialized navigation system or personal audio delivery device.

### Embodiment 18

The system of Embodiment 16 or 17 further comprising program code to identify a non-linear transfer function which spatializes the sound in the direction of travel and wherein the program code to generate the signal that spatializes the sound comprises program code to generate the signal that spatializes the sound based on the non-linear transfer function to spatialize the sound in the direction of travel.

### Embodiment 19

The system of any of Embodiment 16-18, wherein the program code to identify the non-linear transfer function comprises program code to identify the non-linear transfer function from a head related transfer function personalized to a user or a generalized head related transfer function.

### Embodiment 20

The system of any of Embodiment 16-19, wherein the program code to output the signal that spatializes the sound comprises program code to mix the signal with a music signal.

I claim:

1. A method comprising:
determining a direction of travel to a physical destination;
receiving a sound signal indicative of sound;
generating a signal that spatializes the sound in the direction of travel to the physical destination; and
outputting the signal that spatializes the sound to a personal audio delivery device.

2. The method of claim 1, wherein the sound is music or an audio tone.

3. The method of claim 1, wherein the personal audio delivery device is an earbud, a headphone, a behind-the-ear hearing aid, or an in-ear hearing aid, wherein the personal audio delivery device covers at least a portion of a pinna.

4. The method of claim 1, further comprising:
determining a new direction of travel to the physical destination based on a new physical location of the personal audio delivery device;
generating a new signal that spatializes the sound in the new direction of travel; and
outputting the new signal to the personal audio delivery device.

5. The method of claim 1, further comprising identifying a non-linear transfer function which spatializes the sound in the direction of travel and wherein generating the signal that spatializes the sound comprises generating the signal that spatializes the sound based on the non-linear transfer function to spatialize the sound in the direction of travel.

6. The method of claim 5, wherein identifying the non-linear transfer function comprises identifying the non-linear transfer function from a head related transfer function personalized to a user or a generalized head related transfer function.

7. The method of claim 1, wherein the direction of travel is defined by one or more of an azimuth and elevation angle.

8. The method of claim 1, wherein outputting the signal that spatializes the sound comprises mixing the signal that spatializes the sound with a music signal.

9. One or more non-transitory computer readable media comprising program code stored in memory and executable by a processor, the program code to:
determine a direction of travel to a physical destination;
receive a sound signal indicative of sound;
generate a signal that spatializes the sound in the direction of travel to the physical destination; and
output the signal that spatializes the sound to a personal audio delivery device.

10. The one or more non-transitory computer readable media of claim 9, further comprising program code to identify a non-linear transfer function which spatializes the sound in the direction of travel and wherein the program code to generate the signal comprises program code to generate the signal based on the non-linear transfer function to spatialize the sound in the direction of travel.

11. The one or more non-transitory computer readable media of claim 10, wherein the program code to identify the non-linear transfer function comprises program code to identify the non-linear transfer function from a head related transfer function personalized to a user or a generalized head related transfer function.

12. The one or more non-transitory computer readable media of claim 9, wherein the direction of travel is defined by an azimuth and elevation angle.

13. The one or more non-transitory computer readable media of claim 9, wherein the program code to output the signal that spatializes the sound comprises program code to mix the signal with a music signal.

14. The one or more non-transitory computer readable media of claim 9, wherein the sound is music or an audio tone.

15. The one or more non-transitory computer readable media of claim 9, further comprising program code to:
determine a new direction of travel to the physical destination based on a new physical location of the personal audio delivery device;
generate a new signal that spatializes the sound in the new direction of travel; and
output the new signal to the personal audio delivery device.

16. A system comprising:
a personal audio delivery device;
a sound spatialized navigation system comprising:
a navigation device;
program code stored in memory and executable by a processor to cause the system to:
determine a direction of travel to a physical destination;
receive a sound signal indicative of sound;
generate a signal that spatializes the sound in the direction of travel to the physical destination; and
output the signal that spatializes the sound to the personal audio delivery device.

17. The system of claim 16, wherein the program code to determine the direction of travel comprises program code comprises program code to determine a physical location of the sound spatialized navigation system or personal audio delivery device and determine the direction of travel based on the physical location of the sound spatialized navigation system or personal audio delivery device.

18. The system of claim 16, further comprising program code to identify a non-linear transfer function which spatializes the sound in the direction of travel and wherein the program code to generate the signal that spatializes the sound comprises program code to generate the signal that spatializes the sound based on the non-linear transfer function to spatialize the sound in the direction of travel.

19. The system of claim 18, wherein the program code to identify the non-linear transfer function comprises program code to identify the non-linear transfer function from a head related transfer function personalized to a user or a generalized head related transfer function.

20. The system of claim 16, wherein the program code to output the signal that spatializes the sound comprises program code to mix the signal that spatializes the sound with a music signal.
